(19) United States
(12) Patent Application Publication
(10) Pub. No.: US 2012/0278542 A1
(43) Pub. Date: Nov. 1, 2012

(54) COMPUTER SYSTEM AND SLEEP CONTROL METHOD THEREOF

(75) Inventors: Fu-Hsiang Liu, Taipei (TW); Yung-Lang Huang, Taipei (TW); Yu-Chih Liu, Taipei (TW)

(73) Assignee: ASUSTek COMPUTER INC., Taipei (TW)

(21) Appl. No.: 13/454,215

(22) Filed: Apr. 24, 2012

(30) Foreign Application Priority Data
Apr. 27, 2011 (TW) 100114726

(51) Int. Cl. G06F 12/02

(52) U.S. Cl. 711/103; 711/E12.002; 711/E12.008

(57) ABSTRACT

A computer system and a sleep control method thereof are provided. The method includes following steps: when a computer system enters a sleep mode, storing a system parameter into a dynamic random access memory (DRAM) via a central processing unit (CPU); storing the system parameter in the DRAM to a flash memory via a bridge unit; and entering the sleep mode or a power off mode. According to the disclosure, to wake up the computer system is more rapidly and power saving.

### CROSS-REFERENCE TO RELATED APPLICATION

This application claims the priority benefit of Taiwan application serial no. 100114726, filed on Apr. 27, 2011. The entirety of the above-mentioned patent application is hereby incorporated by reference herein and made a part of specification.

### BACKGROUND OF THE INVENTION

1. Field of the Invention

The invention relates to a computer system and, more particularly, to a computer system and a sleep control method thereof.

2. Description of the Related Art

A conventional computer system can save power in a sleep mode. The computer system enters the sleep mode automatically when it is idle for a long time. The sleep mode can further be divided into various modes, such as the S3 sleep mode and the S4 sleep mode according to different power saving degrees.

FIG. 1 is a schematic diagram showing a conventional computer system. A computer system 100 includes a central processing unit (CPU) 110, a control chipset 120, a dynamic random access memory (DRAM) 130, a hard disk 140, an embedded controller 150, a switch 160, and an input device 170 (such as a keyboard). The control chipset 120 includes a north bridge chip 122 and a south bridge chip 126, and the north bridge chip 122 further includes a memory controller 124.

The CPU 110 is connected to the north bridge chip 122, and the memory controller 124 of the north bridge chip 122 is connected to the DRAM 130 and sends out a display signal to an external display (not shown). The south bridge chip 126 is connected to the north bridge chip 122 and the embedded controller 150. The embedded controller 150 is connected to the switch 160 and the input device 170.

The embedded controller 150 of the computer system 100 usually can control power supply and provide power to a part of electronic components according to different sleep modes.

FIG. 2 is a schematic diagram showing power supply of a conventional computer system in the S3 sleep mode. When the computer system 100 enters the S3 sleep mode (shadow zones in FIG. 2 show power off components), the CPU 110 stores all of system parameters to the DRAM 130. Then, the CPU 110, the south bridge chip 126 and a part of the north bridge chip 122 are power off. When the user wants to wake up the computer, he or she presses a button of the input device 170 or a switch 160 to wake it up from the S3 sleep mode. The power is supplied to the CPU 110, the south bridge chip 126 and the north bridge chip 122 again. Then, the CPU 110 uses the memory controller 124 of the north bridge chip 122 to read the system parameters in the DRAM 130, and the computer system 100 is then waken up.

FIG. 3 is a schematic diagram showing power supply of a conventional computer system in the S4 sleep mode (shadow zones in FIG. 3 show the power off components). The CPU 110 stores all of the system parameters to the DRAM 130 first, and stores the system parameters to the hard disk 140. Then, the CPU 110, the north bridge chip 122, the DRAM 130, the south bridge chip 126, the hard disk 140, the input device 170 and the embedded controller 150 are power off. Thus, the system parameters are only stored in the hard disk 140. When the user presses the switch 160 to wake up the computer, the CPU 110 is power on again, and the CPU 110 transfers the system parameters in the hard disk 140 to the DRAM 130 via the south bridge chip 126 and wakes up the computer system 100.

As stated above, at the S3 sleep mode, the system parameters are stored in the DRAM 130, and thus the waking time from the S3 sleep mode is short. However, the computer system 100 also continuously wastes power at the S3 sleep mode.

At the S4 sleep mode, the system parameters are stored in the hard disk 140, and thus the computer system 100 consumes less power. However, in the waking process from the S4 sleep mode, the system parameters are transferred from the hard disk 140 to the DRAM 130, and it takes a long time for the hard disk 140 to get power again and read the system parameters, and thus the waking time from the S4 sleep mode is long.

### BRIEF SUMMARY OF THE INVENTION

A computer system and a sleep control method thereof are disclosed. A bridge unit is connected to a memory bus of the computer system and connected to a flash memory to store system parameters, so as to wake up the computer system rapidly and save power.

The computer system includes a CPU control chipset, a hard disk, an embedded controller, a DRAM, a bridge unit, an input device, a switch and a flash memory. The control chipset is connected to the CPU. The hard disk is connected to the control chipset. The embedded controller is connected to the control chipset and is capable of sending a control signal. The DRAM is connected to the control chipset via the memory bus. The bridge unit is connected to the embedded controller and the DRAM, receives the control signal and reads data in the DRAM according to the control signal. The input device is connected to the embedded controller. The switch is connected to the embedded controller. The flash memory is connected to the bridge unit. When the computer system enters a sleep mode or a power off mode, the embedded controller controls the bridge unit to read a system parameter in the DRAM via the control signal and store the system parameter to the flash memory.

A sleep control method of the computer system is further disclosed. The sleep control method includes following steps: when the computer system enters a sleep mode, storing a system parameter to a DRAM via a CPU; storing the system parameter in the DRAM to a flash memory via a bridge unit; and entering the sleep mode or a power off mode.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a conventional computer system;

FIG. 2 is a schematic diagram showing power supply of a conventional computer system in the S3 sleep mode;

FIG. 3 is a schematic diagram showing power supply of a conventional computer system in the S4 sleep mode;

FIG. 4 is a schematic diagram showing a computer system in a first embodiment;

FIG. 5a and FIG. 5b are schematic diagrams showing power supply when a computer system enters a sleep mode in a first embodiment;

FIG. 6a and FIG. 6b are schematic diagrams showing power supply when a computer system enters another sleep mode in a first embodiment;

FIG. 7 is a schematic diagram showing a computer system in a second embodiment;

FIG. 8 is a schematic diagram showing a computer system in a third embodiment;

FIG. 9a is flow chart showing a control method of entering a flash sleep mode; and

FIG. 9b is a flow chart showing a control method of waking up from a flash sleep mode.

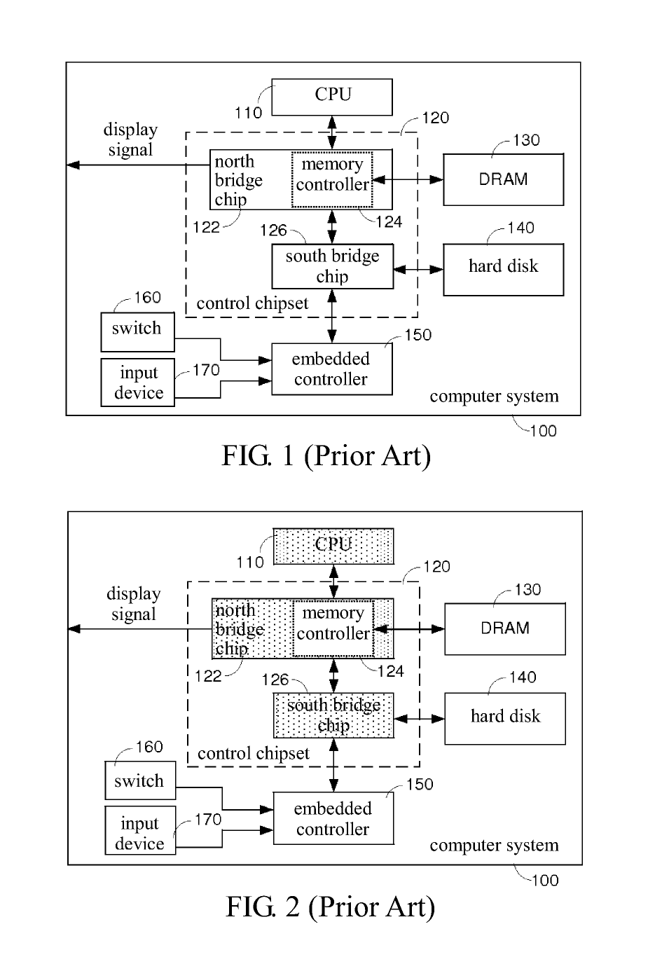

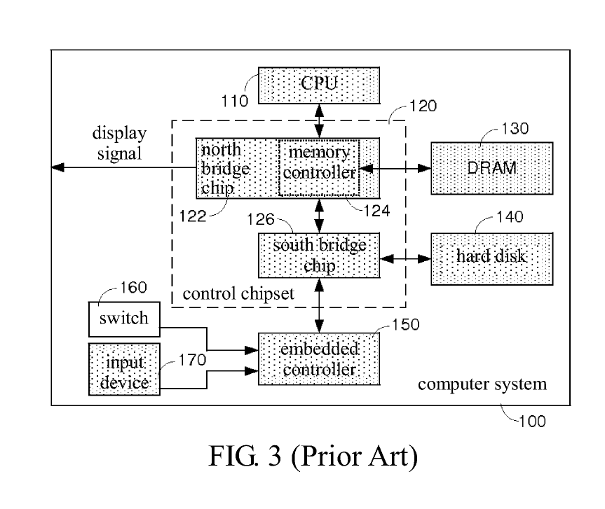

### DETAILED DESCRIPTION OF THE EMBODIMENTS

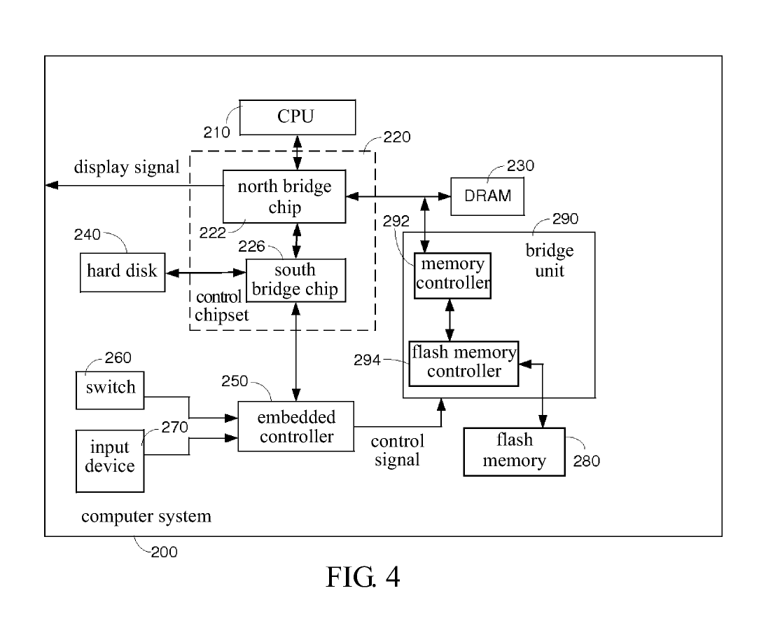

FIG. 4 is a schematic diagram showing a computer system in a first embodiment. The computer system 200 includes a CPU 210, a control chipset 220, a DRAM 230, a hard disk 240, an embedded controller 250, a switch 260, an input device 270, a flash memory 280 and a bridge unit 290. The bridge unit 290 includes a memory controller 292, a flash memory controller 294. The memory controller 292 is connected to the memory bus to access data in the DRAM 230, and the flash memory controller 294 is connected to the flash memory 280. Moreover, when the embedded controller 250 enters a sleep mode or wakes up from the sleep mode, it controls the bridge unit 290 via a control signal, and the control signal is transmitted via a system management bus (SMBus) or an I2C bus.

In an embodiment, no matter which sleep mode the computer system enters, the embedded controller 250 executes a process of entering a flash sleep mode. That is, the embedded controller 250 controls the bridge unit 290 to read system parameters in the DRAM 230 and store the system parameters to the flash memory 280. When the computer system executes the wake up process, the embedded controller 250 executes the waking process of the flash sleep mode. That is, the embedded controller 250 controls the bridge unit 290 to read the system parameters in the flash memory 280 and store the system parameters to the DRAM 230. Then, the computer system 200 is wake up from the S3 sleep mode. The steps of the sleep control method of the flash sleep mode are illustrated in detail as followings.

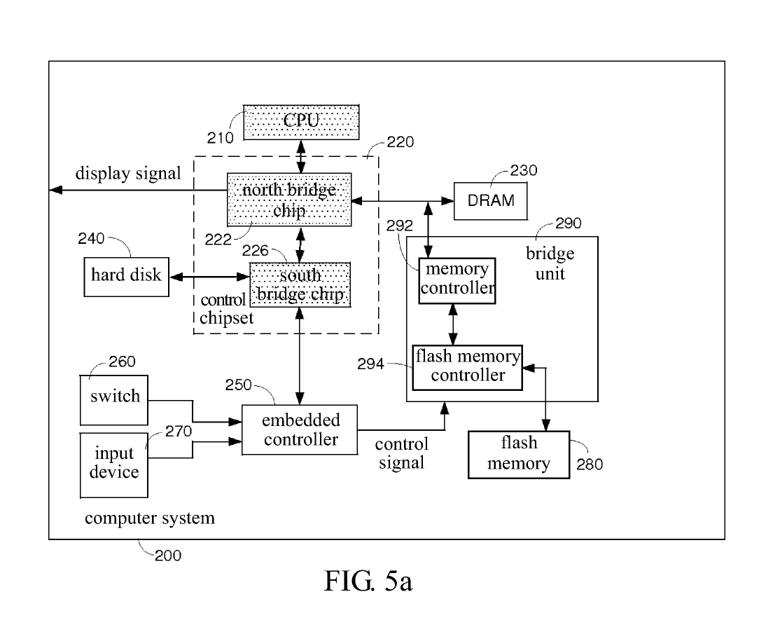

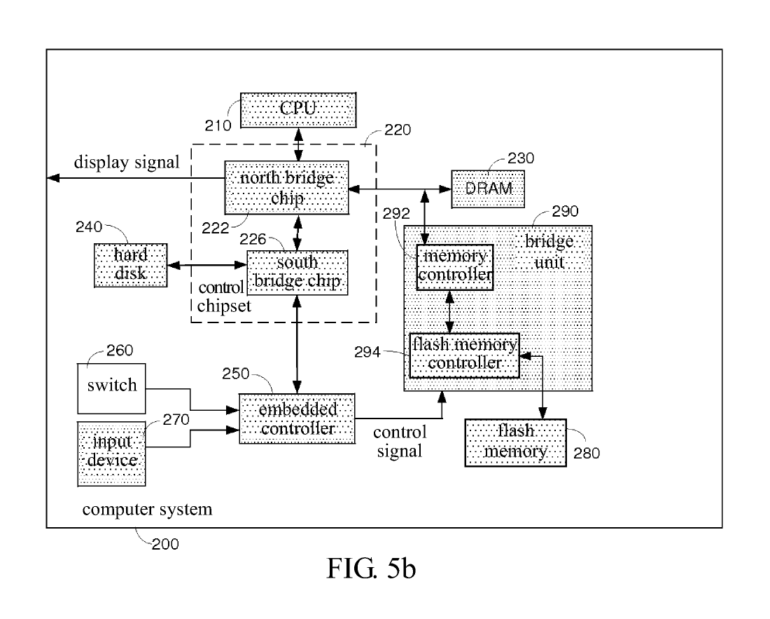

FIG. 5a and FIG. 5b are schematic diagrams showing power supply when a computer system enters a sleep mode in a first embodiment. In the embodiment, two stages of power off process are executed before entering the sleep mode.

When the computer system 200 enters the S3 sleep mode, the embedded controller 250 starts the process of entering the flash sleep mode. The CPU 210 stores the system parameters to the DRAM 230. Then, in the first stage of the power off process in FIG. 5a, the CPU 210, the north bridge chip 222 and the south bridge chip 226 are power off.

Then, the embedded controller 250 does not enter the S3 sleep mode. It controls the memory controller 292 of the bridge unit 290 to read the system parameters in the DRAM 230 via the control signal and utilizes the flash memory controller 294 to write the system parameters to the flash memory 280. In the second stage of power off process in FIG. 5b, the DRAM 230, the bridge unit 290, the flash memory 280, the hard disk 240, the input device 270 and the embedded controller 250 are power off. After the second stage of the power off process is finished, the computer system enters the flash sleep mode. The system parameters are only stored in the flash memory 280 and would not disappear after the flash memory 280 is power off.

When the user presses the switch 260, the waking process from the flash sleep mode is executed. The embedded controller 250 starts the two-stage power on process. In the first stage of the power on process in FIG. 5a, the embedded controller 250, the DRAM 230, the bridge unit 290, the flash memory 280, the hard disk 240 and the input device 270 are power on. Then, the embedded controller 250 controls the flash memory controller 294 of the bridge unit 290 to read the system parameters in the flash memory 280 via the control signal, and utilizes the memory controller 292 to write the system parameters to the DRAM 230.

As shown in FIG. 4, in the second stage of the power on process, after the system parameters are written to the DRAM 230, the embedded controller 250 supplies power to the CPU 210, the north bridge chip 222 and the south bridge chip 226. The embedded controller 250 informs the CPU 210 to utilize the system parameters in the DRAM 230 to wake up the computer system. Thus, the CPU 210 follows the steps of the waking process from the S3 sleep mode, utilizes the north bridge chip 222 to read the system parameters in the DRAM 230 via and wakes up the computer system 200 successfully.

As stated above, when the computer system 200 enters the S3 sleep mode, the CPU 210 writes the system parameters to the DRAM 230. In the embodiment, the embedded controller 250 further controls the bridge unit 290 to write the system parameters of the DRAM 230 to the flash memory 280. After the second stage of the power off process is finished, the computer system 200 enters the flash sleep mode. Comparing with the S3 sleep mode, the flash sleep mode saves more power.

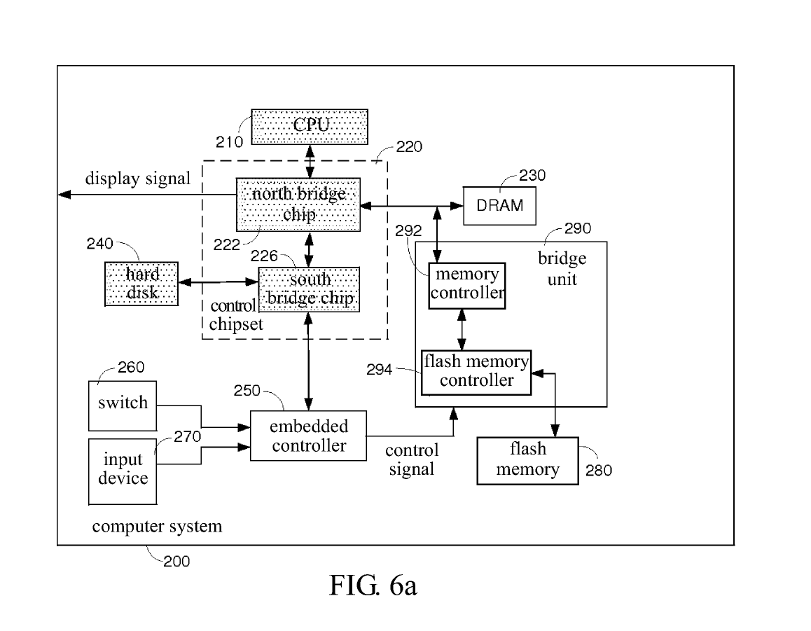

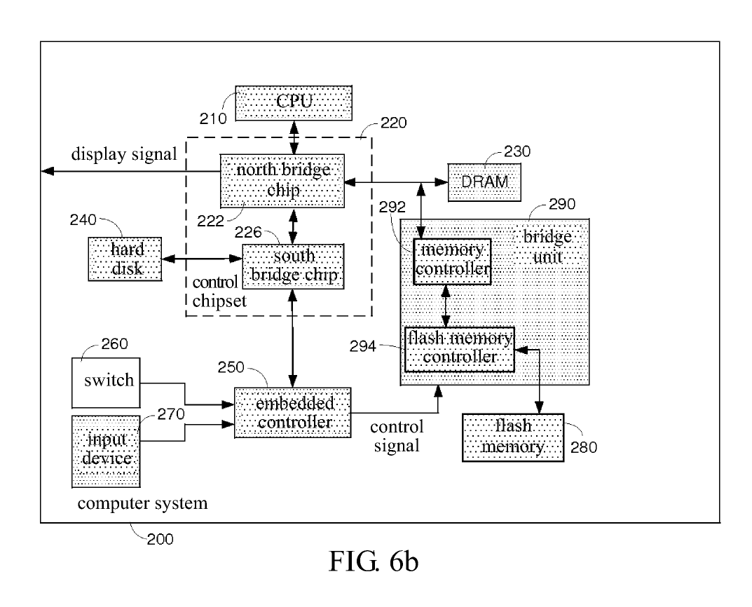

FIG. 6a and FIG. 6b are schematic diagrams showing power supply when a computer system enters another sleep mode in a first embodiment. In the embodiment, two stages of the power off process are executed before the computer system enters the sleep mode.

When the computer system 200 enters the S4 sleep mode, the embedded controller 250 starts the process of entering flash sleep mode. The CPU 210 stores the system parameters to the DRAM 230, and then transfers the system parameters to the hard disk 240. Then, in the first stage of power off process in FIG. 6a, the embedded controller 250 stops supplying power to the CPU 210, the north bridge chip 222, the south bridge chip 226 and the hard disk 240.

Then, the embedded controller 250 does not enter the S4 sleep mode. It controls the memory controller 292 of the bridge unit 290 to read the system parameters in the DRAM 230 via the control signal and utilizes the flash memory controller 294 to write the system parameters to the flash memory 280. In the second stage of power off process in FIG. 6b, the DRAM 230, the bridge unit 290, the flash memory 280, the input device 270 and the embedded controller 250 are power off. After the second stage of the power off process is finished, the computer system enters the flash sleep mode. The system parameters are only stored in the flash memory 280 and the hard disk 240 and would not disappear after the flash memory 280 and the hard disk 240 are power off.

When the user presses the switch 260, the waking process from the flash sleep mode is executed. The embedded controller 250 starts the two-stage power on process. In the first stage of the power on process in FIG. 6a, the embedded controller 250, the DRAM 230, the bridge unit 290, the flash memory 280 and the input device 270 are power on. Then, the embedded controller 250 controls the flash memory controller 294 of the bridge unit 290 to read the system parameters in the flash memory 280 via the control signal, and utilizes the memory controller 292 to write the system parameters to the DRAM 230.

In the second stage of the power on process, as shown in FIG. 4, after the system parameters are written to the DRAM 230, the embedded controller 250 supplies power to the CPU 210, the north bridge chip 222, the south bridge chip 226 and the hard disk 240. Then, the embedded controller 250 informs the CPU 210 to wake up the computer system 200 via the system parameters in the DRAM 230 but not the system parameters in the hard disk 240.

That is, the embedded controller 250 would not inform the CPU 210 to wake up the computer system 200 according to the waking process from the S4 sleep mode, but according to the waking process from the S3 sleep mode. The north bridge chip 222 reads the system parameters in the DRAM 230 and wakes up the computer system 200 successfully.

As stated above, when the computer system 200 enters the S4 sleep mode, the CPU 210 writes the system parameters to the DRAM 230 and transfers the system parameters to the hard disk. In the embodiment, the embedded controller 250 further controls the bridge unit 290 to write the system parameters in the DRAM 230 to the flash memory 280. After the second stage of the power off process is finished, the computer system 200 enters the flash sleep mode. Comparing with the conventional waking up process from the S4 sleep mode in which the system parameters are read from the hard disk 240, the flash sleep mode shortens the time of waking the computer system.

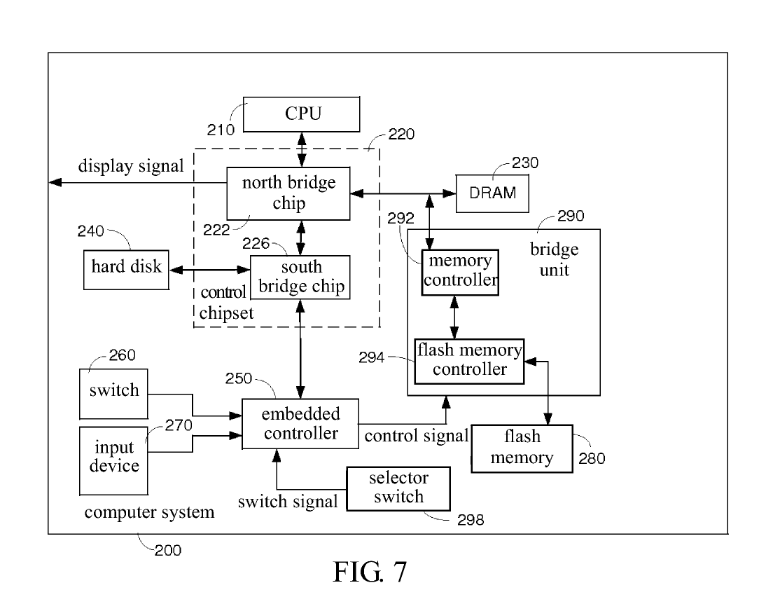

FIG. 7 is a schematic diagram showing a computer system in a second embodiment. Comparing with the first embodiment, a switch 298 is provided for the user to switch manually in the second embodiment. The switch 298 outputs a switch signal to the embedded controller 250, and thus the computer system 200 may have different waking up processes at the S5 mode. For example, when the switch 298 outputs a first level, it selects instant power on, and when it outputs a second level, it selects regulator power on.

Since the S5 mode is the power off mode of the computer system, when the user shuts down the computer system, the CPU 210 stores the system parameters in the DRAM 230. Then, as the first stage of the power off process shown in FIG. 6a, the embedded controller 250 stops supplying power to the CPU 210, the north bridge chip 222, the south bridge chip 226 and the hard disk 240.

Then, the embedded controller 250 does not enter the S5 mode. It controls the memory controller 292 of the bridge unit 290 to read the system parameters in the DRAM 230 via the control signal and utilizes the flash memory controller 294 to write the system parameters to the flash memory 280. Then, in the second stage of power off process in FIG. 6b, the DRAM 230, the bridge unit 290, the flash memory 280, the input device 270 and the embedded controller 250 are power off. After the second stage of the power off process is finished, the computer system enters the flash sleep mode. The system parameters are only stored in the flash memory 280 and would not disappear after the flash memory 280 is power off.

When the user presses the switch 260 to reboot the computer system, the embedded controller 250 determines how to wake up the computer system 200 according to the switch signal. If the switch signal is at the first level, it means that the user wants to boot up the computer system instantly. Thus, the embedded controller 250 starts the instant power on waking process from the flash sleep mode and executes the two-stage power on process as shown in FIG. 6b and FIG. 4. That is, the embedded controller 250 informs the CPU 210 and utilizes the north bridge chip 222 to read the system parameters of the DRAM 230 and wake up the computer system 200 successfully according to the waking up steps from the S3 sleep mode.

On the contrary, if the switch signal is at the second level when the user presses the switch 260 to reboot the computer system, it means the user wants to boot up the computer system in regulator power on mode. The CPU 210 reads the operation system data in the hard disk 240 to boot up the computer system 200.

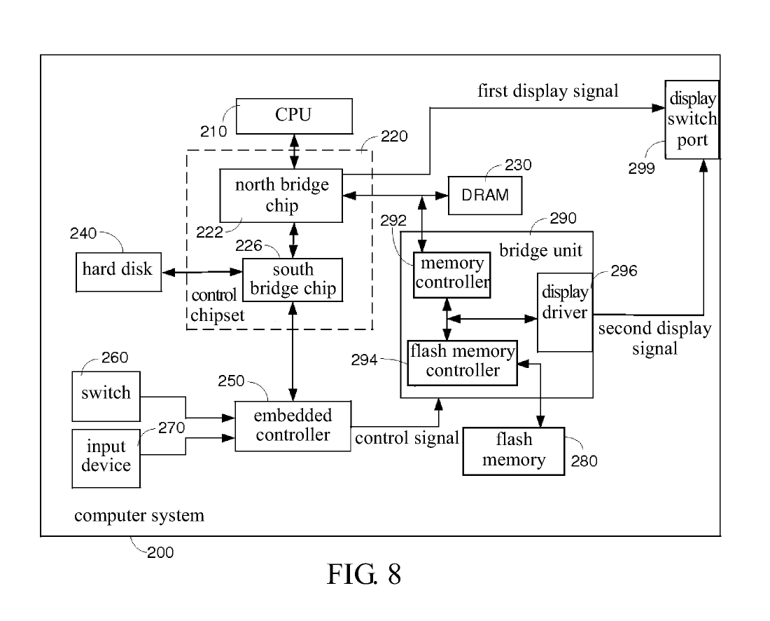

FIG. 8 is a schematic diagram showing a computer system in a third embodiment. Comparing with the first embodiment, the bridge unit 290 further includes a display driver 296, and the computer system 200 further includes a display switch port 299 in the third embodiment. The display switch port 299 can outputs a first display signal generated by the north bridge chip 222 or a second display signal generated by the display driver 296 to an external display (not shown). The first display signal and the second display signal may be a low-voltage differential signal (LVDS), and the display switch port 299 may be a LVDS switch port.

According to the third embodiment, the computer system 200 may shut down most of the power at a reading mode, read the data in the flash memory 280 via the bridge unit 290 and display the data at the external display (not shown). Thus, the computer system 200 can save power at the reading mode.

Since the user does not need edit at the reading mode of the computer system 200, only the bridge unit 290, the display switch port 299 and the flash memory 280 are power on.

When the user controls the computer system 200 to enter the reading mode, the CPU 210 stores the system parameters to the DRAM 230. The embedded controller 250 controls the memory controller 292 of the bridge unit 290 to read the system parameters in the DRAM 230 via the control signal, and utilizes the flash memory controller 294 to write the system parameters to the flash memory 280. Then, only the bridge unit 290, the display switch port 299 and the flash memory 280 are power on.

Since the DRAM 230 and the north bridge chip 222 are power off, the north bridge chip 222 cannot generate the first display signal. Since the system parameters of the DRAM 230 are stored to the flash memory 280, the display driver 296 can generate the second display signal accordingly, and the display switch port 299 outputs the second display signal to the external display (not shown). Consequently, the display driver 296 can display the reading screen for the user at the reading mode without changing the system parameters.

When the user wants to leave the reading mode, he or she only needs to press the switch 260, and the embedded controller 250 executes the same waking process. That is, the embedded controller 250 writes the system parameters to the DRAM 230 first, and then the embedded controller 250 informs the CPU 210 to wake up the computer system via the system parameters in the DRAM 230.

As stated above, the computer system 200 can save more power at the reading mode.

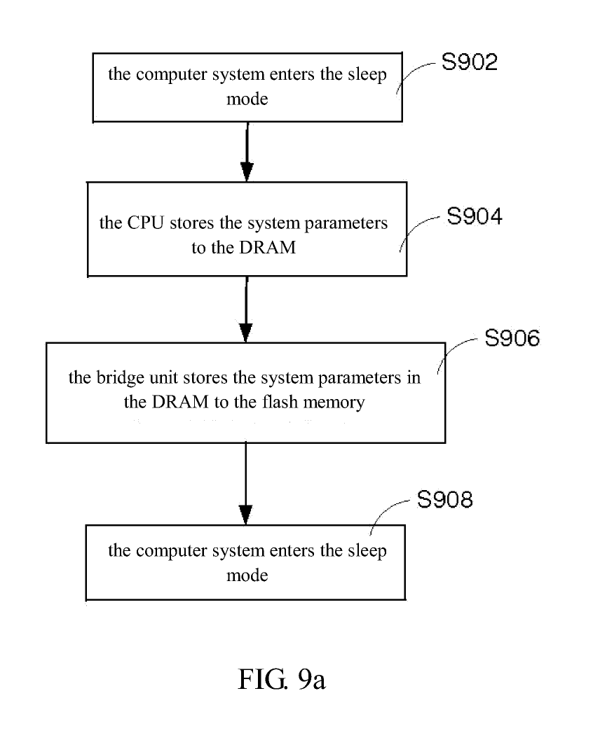

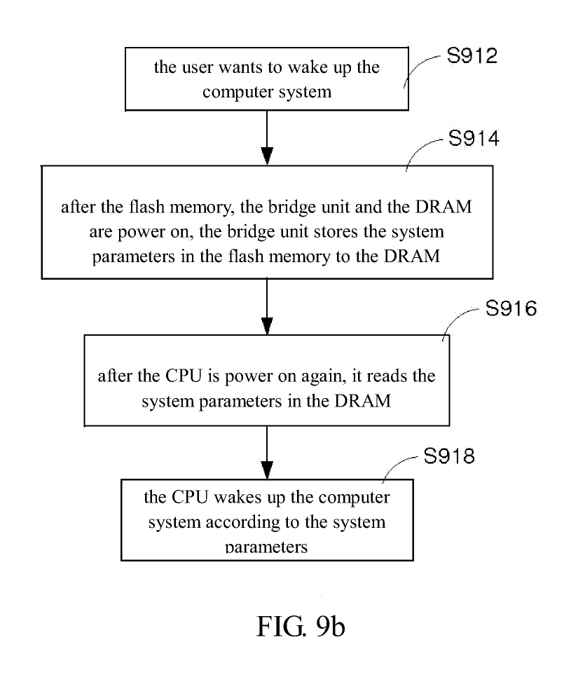

FIG. 9a is flow chart showing a control method of entering a flash sleep mode. When the computer system enters the sleep mode (step S902), the CPU stores the system parameters to the DRAM (step S904). The bridge unit stores the system parameters in the DRAM to the flash memory (step S906). The electronic components are power off and the computer system enters the sleep mode (step S908).

As shown in FIG. 9a, the embedded controller can execute the two-stage power off process. After the system parameters are stored to the DRAM (step S904), the CPU, the north bridge chip and the south bridge chip are power off. After the flash memory stores the system parameters (step S906), other electronic components are power off, and only the switch is power on.

The embedded controller can also execute a one-stage power off process. After the flash memory stores the system parameters (step S906), the embedded controller stops supplying power to all of the electronic components, and only the switch is power on.

FIG. 9b is a flow chart showing a control method of waking up from a flash sleep mode. When the user wants to wake up the computer system (step S912), after the flash memory, the bridge unit and the DRAM are power on, the bridge unit stores the system parameters in the flash memory to the DRAM (step S914). After the CPU is power on again, it reads the system parameters in the DRAM (step S916), and the computer system is waken up according to the system parameters (step S918).

As stated above, a computer system and a sleep control method thereof are disclosed. A bridge unit is connected to a memory bus of the computer system, and it is connected to a flash memory to store system parameters, so as to wake up the computer system rapidly and save power.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A computer system, comprising:
a central processing unit (CPU);
a control chipset connected to the CPU;
a hard disk connected to the control chipset;
an embedded controller connected to the control chipset and sending a control signal;
a dynamic random access memory (DRAM) connected to the control chipset via a memory bus;
a bridge unit connected to the embedded controller and the DRAM, receiving the control signal, and reading data in the DRAM according to the control signal;
an input device connected to the embedded controller;
a switch connected to the embedded controller; and
a flash memory connected to the bridge unit;
wherein when the computer system enters a sleep mode or a power off mode, the embedded controller controls the bridge unit to read a system parameter in the DRAM via the control signal and store the system parameter to the flash memory.

2. The computer system according to claim 1, when the computer system is waken up from the sleep mode, the embedded controller controls the bridge unit to read the system parameter in the flash memory and store the system parameter to the DRAM according to the control signal.

3. The computer system according to claim 1, wherein the computer system further includes a switch connected to the embedded controller to provide a first level or a second level, after the computer system enters the power off mode and when the switch is pressed and the switch outputs the first level, the embedded controller controls the bridge unit to read the system parameter in the flash memory according to the control signal, stores the system parameter to the DRAM and informs the CPU to wake up the computer system according to the system parameter in the DRAM.

4. The computer system according to claim 3, after the computer system enters the power off mode, and when the switch is pressed and the switch outputs the second level, the CPU reads operation system data in the hard disk to boot the computer system.

5. The computer system according to claim 1, wherein the control chipset is to output a first display signal, the bridge unit includes a display driver used to output a second display signal, and the computer system includes a display switch port for receiving the first display signal and the second display signal, when the computer system enters a reading mode, the bridge unit reads the system parameter in the flash memory according to the control signal, and the display driver generates the second display signal and outputs the second display signal to an external display via the display switch port.

6. The computer system according to claim 1, wherein the bridge unit includes:
a memory controller connected to the memory bus; and
a flash memory controller connected to the memory controller and the flash memory;
wherein the memory controller reads the system parameter in the DRAM and stores the system parameter to the flash memory via the flash memory controller, or the flash memory controller reads the system parameter in the flash memory and stores the system parameter to the DRAM via the memory controller.

7. A sleep control method of a computer system, comprising following steps:
storing a system parameter to a DRAM via a CPU when the computer system enters a sleep mode;
storing the system parameter in the DRAM to a flash memory via a bridge unit; and
entering the sleep mode or a power off mode.

8. The sleep control method of the computer system according to claim 7, wherein the sleep control method further includes following steps:
when the computer system is restored or booted, supplying power to the flash memory, the bridge unit and the DRAM;
storing the system parameter in the flash memory to the DRAM via the bridge unit; and
reading the system parameter in the DRAM to wake up the computer system after the CPU is powered.

9. The sleep control method of the computer system according to claim 7, wherein a step is further includes after the step of storing a system parameter to a DRAM via a CPU when the computer system enters a sleep mode:
stopping supplying power to the CPU and a control chipset.
